(19) United States
(12) Patent Application Publication
(10) Pub. No.: US 2019/0322360 A1
(43) Pub. Date: Oct. 24, 2019

(54) AIRCRAFT UNDERCARRIAGE HAVING A STEERABLE BOTTOM PORTION, AND A SIMPLIFIED STEERING DEVICE

(71) Applicants: Bertrand Dubacher, Moissy-Cramayel (FR); Bertrand Euzet, Moissy-Cramayel (FR); Marc Quenerch'Du, Moissy-Cramayel (FR)

(72) Inventors: Bertrand Dubacher, Moissy-Cramayel (FR); Bertrand Euzet, Moissy-Cramayel (FR); Marc Quenerch'Du, Moissy-Cramayel (FR)

(73) Assignee: SAFRAN LANDING SYSTEMS, Velizy Villacoublay (FR)

(21) Appl. No.: 16/387,188

(22) Filed: Apr. 17, 2019

(30) Foreign Application Priority Data
Apr. 18, 2018 (FR) 1853399

(51) Int. Cl. B64C 25/50; B64C 25/34; F16H 49/00; F16H 1/06; F16H 37/04

(52) U.S. Cl. CPC B64C 25/50; B64C 25/34; B64C 2025/345; F16H 1/06; F16H 37/041; F16H 49/001

(57) ABSTRACT

An aircraft undercarriage includes a steerable bottom portion carrying one or more wheels and fitted with a steering device configured to turn the steerable bottom portion in response to a steering order. The steering device has a single electromechanical steering actuator having a steering electric motor driving, by a reduction gearing, an outlet pinion on an axis of the steering electric motor. The outlet pinion cooperates with a spur gear secured to the steerable bottom portion. A connection between the steering electric motor and the steerable bottom portion is reversible. The electromechanical steering actuator is fitted with a monitor configured to monitor at least one operating parameter of the steering device and to detect an actuator performance deterioration condition.

### CROSS-REFERENCE TO RELATED APPLICATION

This application claims priority to French Application No. 1853399, filed Apr. 18, 2018, the disclosure of which is incorporated herein by reference in its entirety.

### BACKGROUND

For aircraft of a certain size, a nose undercarriage is generally fitted with a device for steering its wheels in order to make the aircraft easier to move on the ground and enabling it to make turns. The steering function is very useful for taxiing the aircraft, but it is not considered as being critical, in the sense that loss of this function, at least temporarily, can be mitigated by applying differential braking to steer the aircraft. Nevertheless, even in the event of losing the steering function, the direction of the wheels should not become jammed such that they lose the capability to swivel freely. The steering device should also be compatible with the tow vehicle, e.g., by way of a tow bar attached to the steerable bottom portion of the undercarriage.

Previous undercarriages have included steering actuators, such as the undercarriage described in EP 1 845 016; however, the actuators may be irreversible. Such devices are complex and expensive (especially when applied to smaller aircraft, such as business airplanes), and the irreversibility risks jamming wheel direction and preventing any control over steering in the event of one of the actuators failing. Thus, there is a continued need for improved undercarriages.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In an aspect, the present disclosure provides an aircraft undercarriage including a steerable bottom portion carrying one or more wheels and fitted with a steering device configured to turn the steerable bottom portion in response to a steering order. The steering device in some embodiments has a single electromechanical steering actuator comprising an electric motor driving an outlet pinion on the axis of the motor by a reduction gearing of the deformable bell type (or “harmonic drive”), the outlet pinion cooperating with a spur gear secured to the steerable bottom portion, the connection between the electric motor and the steerable bottom portion being reversible, and the actuator being fitted with a monitor for monitoring at least one operating parameter of the steering device and configured to detect a deterioration in the performance of the actuator.

The steering actuator no longer includes any coupling/decoupling means, thereby improving simplicity. It remains continuously connected to the steerable bottom portion of the undercarriage, but without that impeding free swiveling of the bottom portion during turning or in the event of the motor failing, since the connection between the electric motor and the steerable bottom portion is reversible, even if the motor is not powered or has failed. The drive train between the outlet pinion and the motor is simple and the reduction gearing used is very unlikely to jam, such that any risk of the actuator jamming is minimized by construction. Nevertheless, and in order to further reduce this risk, the monitor serves to anticipate a potential failure of the actuator so that it can be replaced before the failure takes place, thereby making the occurrence of jamming extremely improbable.

These technical options enable the steering function to be provided while using a single actuator that is very simple and while complying with the expected functional criteria.

### DESCRIPTION OF THE DRAWINGS

The foregoing aspects and many attendant advantages of the present disclosure will become more readily appreciated as the same become better understood by reference to the following detailed description, when taken in conjunction with the accompanying drawings, wherein:

FIG. 1 is a diagrammatic view of the bottom of an undercarriage fitted with a steering device having an electromechanical steering actuator, according to an embodiment of the present disclosure;

FIG. 2 is a plan view of the FIG. 1 undercarriage; and

FIG. 3 is a view of the electromechanical steering actuator in section on line III-III of FIG. 2.

### DETAILED DESCRIPTION

In the following description, specific details are set forth to provide a thorough understanding of exemplary embodiments of the present disclosure. It will be apparent to one skilled in the art, however, that the embodiments disclosed herein may be practiced without embodying all of the specific details. In some instances, well-known process steps have not been described in detail in order not to unnecessarily obscure various aspects of the present disclosure. Further, it will be appreciated that embodiments of the present disclosure may employ any combination of features described herein.

The present disclosure may also reference quantities and numbers. Unless specifically stated, such quantities and numbers are not to be considered restrictive, but exemplary of the possible quantities or numbers associated with the present application. Also in this regard, the present application may use the term “plurality” to reference a quantity or number.

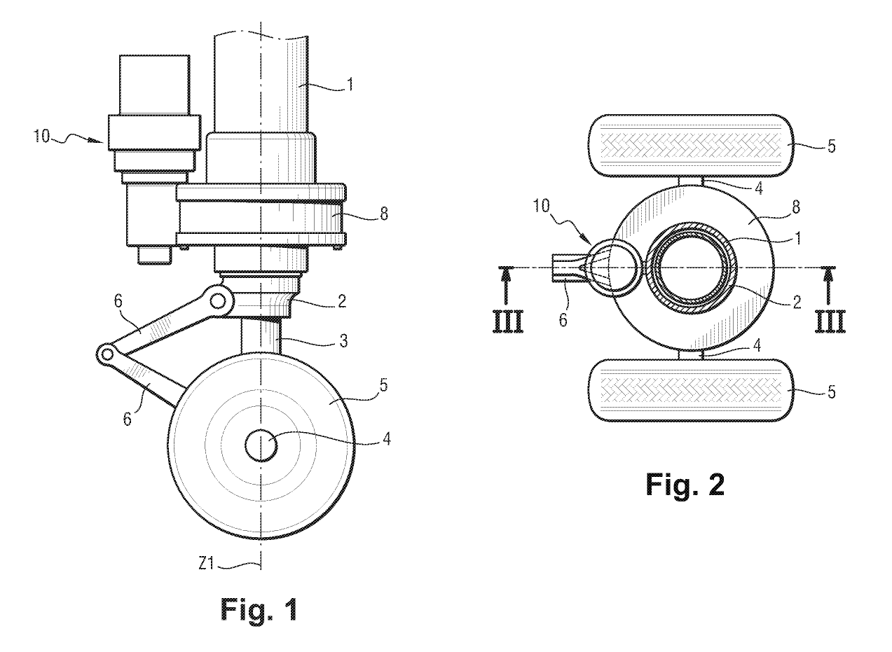

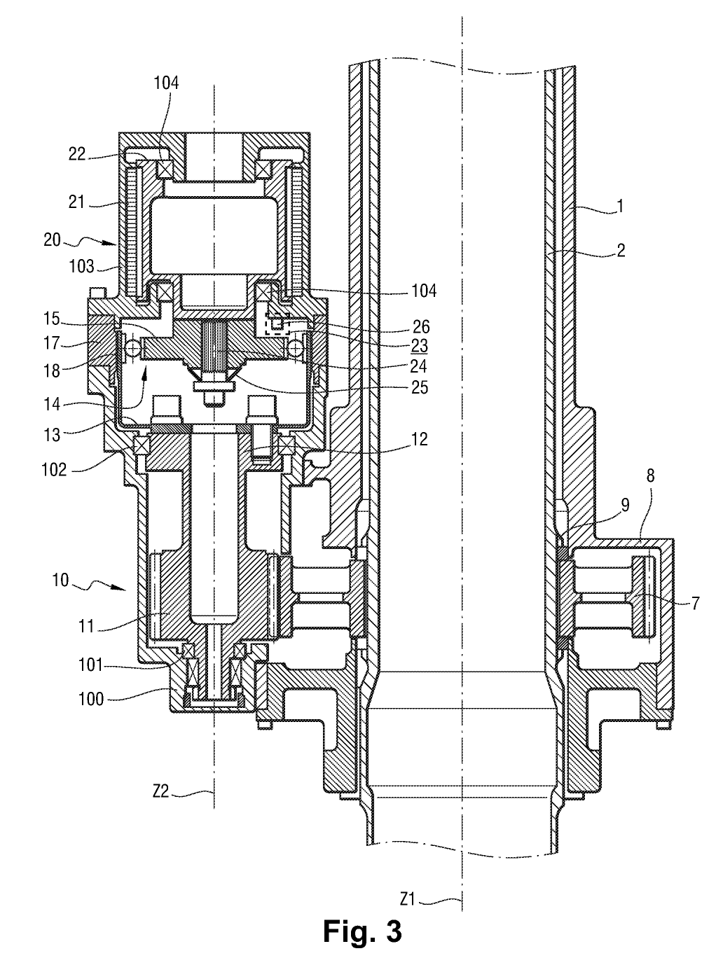

With reference to FIGS. 1 and 2, and in one embodiment of the present disclosure, the undercarriage shown comprises a strut-leg 1 in which a turnable tube 2 is mounted to turn about a longitudinal axis Z1. A telescopic shock absorber 3 extends inside the turnable tube 2. The bottom portion of the shock absorber projects from the tube 2 and carries an axle 4 receiving wheels 5. A scissors linkage 6 extends between the turnable tube 2 and the shock absorber 3 in order to constrain the turnable tube 2 and the shock absorber 3 to turn together, while still allowing the shock absorber to move freely into the strut-leg 1 along the axis Z1. The turnable tube 2 carries a spur gear 7 (visible in FIG. 3) at its bottom end, which spur gear is received in a housing 8 of the strut-leg 1 and is constrained to turn together with the turnable tube 2 by fluting 9.

In the illustrated embodiment, the undercarriage is fitted with a steering device having a single electromechanical steering actuator 10 configured to cooperate with the spur gear 7 in order to turn the tube 2, and thus the wheels 5, by the scissors linkage 6. In this example, the electromechanical steering actuator 10 forms a unit module that is fitted onto the housing 8 of the strut-leg 1 so as to be easily removable.

With reference to FIG. 3, the spur gear 7 is engaged by an outlet pinion 11 of the electromechanical steering actuator 10, which pinion is mounted thereon so as to be rotatable about an axis Z2 parallel to the axis Z1 of the undercarriage. In this example, the pinion 11 is made integrally with a spindle 12 mounted to rotate freely in a casing 100 of the actuator 10 by rolling bearings 101 and 102. The spindle 12 is secured to the outlet member 13 of reduction gearing 14 of the “harmonic drive” type as described in particular in U.S. Pat. No. 2,906,143, which is herein incorporated by reference. In some embodiments, the reduction gearing 14 may be a different type. The outlet member 13 has a circular wall 18 in the form of a deformable bell that carries on its outside face teeth for cooperating with a slightly greater number of facing teeth of a ring 17 secured to the casing 100. Cooperation between the teeth of the outlet member 13 and of the ring 17 is made possible by the circular wall 18 being deformed by an inlet member 15 of the reduction gearing (referred to as a “wave generator”), that forces cooperation between the teeth in two diametrically opposite portions. It should be observed that in this example the ring 17 forms a portion of the casing of the electromechanical steering actuator.

The inlet member 15 of the reduction gearing 14 is driven in rotation by an electric motor 20 comprising a stator 21 carried by a portion 103 of the casing 100 secured to the ring 17, and a rotor 22 rotatably mounted in the casing portion 103 by rolling bearings 104. The rotor 22 has a fluted outlet shaft 24 engaged in a matching fluted orifice of the inlet member 15 in order to drive it in rotation. Controlled rotation of the rotor 22 causes the pinion 11 to rotate via the reduction gearing 14 and thereby turns the spur gear 7 and thus steers the wheel 5.

By way of illustration, the reduction ratio between the pinion 11 and the spur gear 7 is about 5, while the reduction ratio of the reduction gearing 14 is about 100, thereby giving an overall reduction ratio of about 500. Nevertheless, this connection is reversible. For this purpose, it is appropriate to ensure that the residual torque of the electric motor 20 is particularly low, and to minimize all friction within the actuator 10. Reversibility enables the bottom portion of the undercarriage to swivel freely under the action of a tow bar, without any need to disconnect the steering device. It also enables the bottom portion of the undercarriage to swivel freely when the motor of the actuator has failed or is no longer powered, with the pilot still being able to steer the aircraft on the ground by differential braking.

The structure of the actuator is not at all prone to jamming. Nevertheless, in order to guarantee a very low rate of jamming occurring, the electromechanical actuator 10 is provided in some embodiments with a monitor 23 that is configured to monitor at least one operating parameter of the steering device and suitable for detecting a deterioration in the performance of the actuator. The monitor 23 anticipates any possible failure of the actuator so as to make preventative replacement possible, thereby greatly reducing any risk of the actuator jamming and thus of the bottom portion being jammed. The monitor 23 may include a device (e.g., a sensor such as a transducer) that measures a torque transmitted by the reduction gearing 14. The monitor 23 may also include or is connected to a device (e.g., a controller having a logic circuit, a processor, a data store, a transponder, and/or a transceiver) that generates a warning in response to detecting an increase in said torque for a given steering setpoint greater than a given threshold. As can be seen in FIG. 3, the inlet member 15 is slidably mounted on the fluted outlet shaft 24 of the motor 20 against a spring washer 25 that urges the inlet member towards the rotor 22. Specifically, the reduction gearing 14 transmitting torque generates an axial force on the inlet member 15 that is proportional to the torque, such that the inlet member 15 moves axially against the return force of the spring washer 25. An axial movement sensor 26, e.g., an eddy current sensor extending facing the inlet member 15, measures the axial movement of the inlet member 15, and thus make it possible to deduce the torque being transmitted by the reduction gearing 14. The axial movement sensor 26 is associated with a calculator (e.g., a general processing unit, a graphical processing unit, an application specific integrated circuits, and/or a module that may be implemented as software logic, firmware logic, hardware logic (analog and/or digital circuitry), or various combinations thereof) that calculates or otherwise determines the transmitted torque on the basis of the measured axial movement of the inlet member 15 and generates a warning in response to detecting an increase in said torque beyond a given threshold, which is a sign that the performance of the electromechanical actuator 10 is deteriorating (an actuator performance deterioration condition). The warning is given soon enough to enable maintenance crew to have enough time to replace the electromechanical actuator 10 before it fails.

While illustrative embodiments have been illustrated and described, it will be appreciated that various changes can be made therein without departing from the spirit and scope of the present disclosure, which is not limited to the above description, but on the contrary covers any variant coming within the ambit defined by the claims. In particular, the monitor may monitor any other operating parameter of the steering device, for example the current drawn by the motor 20 of the actuator in order to obtain a given amount of steering.

The embodiments of the invention in which an exclusive property or privilege is claimed are defined as follows:

1. An aircraft undercarriage, comprising:
a steerable bottom portion carrying one or more wheels; and
a steering device fitted to the steerable bottom portion and configured to turn the steerable bottom portion in response to a steering order, the steering device having a single electromechanical steering actuator having a steering electric motor driving an outlet pinion on a motor axis by a reduction gearing, the outlet pinion cooperating with a spur gear secured to the steerable bottom portion, the steering electric motor being reversibly connected to the steerable bottom portion, and the electromechanical steering actuator being fitted with a monitor that is configured to monitor at least a first operating parameter of the steering device and is configured to detect an actuator performance deterioration condition.

2. The aircraft undercarriage according to claim 1, wherein the monitor is configured to measure a torque transmitted by the reduction gearing.

3. The aircraft undercarriage according to claim 2,
wherein the reduction gearing has an inlet member driven by a rotor of the steering electric motor, the reduction gearing being slidably mounted on the rotor against a resilient return member,
wherein the monitor comprises:
a sensor configured to measure an axial movement of the inlet member caused by the torque transmitted by the reduction gearing, and
a calculator configured to estimate a torque associated with the axial movement of the inlet member and to generate a warning in response to detecting an increase of the torque beyond a threshold.

4. The aircraft undercarriage according to claim 3, wherein the sensor is an eddy current sensor.

5. The aircraft undercarriage according to claim 1, wherein the reduction gearing is a deformable bell type reduction gearing.

6. An aircraft undercarriage, comprising:
a steerable bottom portion carrying one or more wheels; and
a steering device fitted to the steerable bottom portion and configured to turn the steerable bottom portion in response to a steering order, the steering device having a single electromechanical steering actuator having a steering electric motor driving an outlet pinion on a motor axis by a reduction gearing, the outlet pinion cooperating with a spur gear secured to the steerable bottom portion, the steering electric motor being reversibly connected to the steerable bottom portion, and the electromechanical steering actuator being fitted with a monitor means for monitoring at least a first operating parameter of the steering device and for detecting an actuator performance deterioration condition.

7. The aircraft undercarriage according to claim 6, wherein the monitor means comprises a torque measurement means for measuring a torque transmitted by the reduction gearing.
